(19) United States
(12) Patent Application Publication
(10) Pub. No.: US 2022/0202039 A1
(43) Pub. Date: Jun. 30, 2022

(54) PROCESS AND COMPOSITION FOR PLANT-BASED FOOD PRODUCTS

(71) Applicant: The Livekindly Company Switzerland GmbH, Pfäffikon (CH)

(72) Inventor: Achim Knoch, Minden (DE)

(21) Appl. No.: 17/543,358

(22) Filed: Dec. 6, 2021

Related U.S. Application Data
(60) Provisional application No. 63/132,323, filed on Dec. 30, 2020.
(60) Provisional application No. 63/180,921, filed on Apr. 28, 2021.

(51) Int. Cl. A23J 3/22; A23L 3/36; A23J 3/26; A23J 3/16; A23J 3/18

(52) U.S. Cl. CPC A23J 3/227; A23L 3/36; A23J 3/18; A23J 3/16; A23J 3/26

(57) ABSTRACT

The present disclosure relates to a process and composition of preparing and processing plant-based food products such as vegan food products, wherein plant protein and water is mixed in a defined ratio in a batch and fed into an extruder using a sausage filler, creating a system wherein air from the dough cannot leave the system and back into the feeding side. The dough is subjected to a high moisture extrusion process, wherein the air within the dough is homogeneously distributed as fine air bubbles imparting a texture and lighter color similar to a meat-based food color.

### PRIORITY CLAIM AND CROSS-REFERENCE TO RELATED APPLICATIONS

This application claims priority of the following provisional patent applications:
1. Prov. App. Ser. No. 63/132,323 titled “Process and Composition for Plant-Based Food Products,” by Achim Knoch filed on Dec. 30, 2020; and
2. Prov. App. Ser. No. 63/180,921 titled “Rework Process for Plant-Based Food Production,” by Achim Knoch filed on Apr. 28, 2021.
   All of the above-listed US provisional patent applications are incorporated by reference herein in its entirety, including all references and appendices cited therein, for all purposes.

This application is also related to U.S. application Ser. No. ______, filed on ______, entitled “Rework Process for Plant-Based Food Production,” by Achim Knoch (Atty. Docket Number 9740US), which is hereby incorporated by reference herein in its entirety, including all references and appendices cited therein, for all purposes.

### FIELD OF THE INVENTION

The invention relates to a process and composition for preparing plant-based food products, such as vegan food products.

### BACKGROUND

In modern society, people are adopting a variety of eating lifestyles, one of them eating vegan food. People adopting a vegan lifestyle eliminate animal-derived food products from their food. Consumers are increasingly becoming aware of foods that they ingest and developing increasing awareness about the manner in which foods are produced. This increased awareness and search for alternate food options without compromising color, texture, taste, or looks of meat like food products is expanding research areas as companies are exploring protein sources available from plants, alternate vegetarian sources, or other non-meat sources. However, any such plant-based food products or vegan food products lack texture, taste, structure, or color compared to meat-based food products or animal-based food products. The consumer either goes back to eating meat products or compromises with the taste and texture and adjusts their eating habits.

The present disclosure addresses these problems and provides a composition and a process of preparing plant-based food products such as a vegan food product with a texture, color, or appearance mirroring a meat food product.

### SUMMARY

In summary, provided herein is a process of making a plant-based food product, such as a vegan food product, its processing and composition. More particularly, provided herein is a process and a composition of making a plant-based food product, such as a vegan food product mirroring a meat-based food product in appearance, taste, color, or texture.

In various embodiments, provided herein is a method of processing a plant-based food product, comprising: providing a batch of material comprising at least a plant protein and at least an aqueous phase, preferably water, introduced simultaneously into a mixer, wherein the mixer blends the plant protein and water forming a dough which is dry and crumbly with air trapped within; feeding the dough through a feeding side of an extruder via a sausage filler, wherein the use of the sausage filler forms a closed system preventing air from the dough from leaving the system and back into the feeding side; subjecting the dough to a high moisture extrusion (HME) process forming HME material; optionally providing at least an ingredient in a cooking tumbler to add flavor, texture, nutrients, taste, or color to the HME material, wherein the ingredient may be added after cutting the HME material; and cutting the HME material in chunks of any shape or size, wherein the HME material may be a component for making a plant-based food product or used directly as a final food product. The HME material is processed dough, wherein the dough fed into the extruder undergoes HME process and is processed for preparing plant-based food product.

In various other embodiments, the method further comprises: passing the HME material through a cooling die; cutting the HME materials into chunks, heating the chunks, wherein the HME material in the form of chunks may be heated at a temperature of at least 80° C. or more than 80° C.; freezing the HME material as chunks, wherein the HME material is freeze using IQF-freezing for preservation, packaging, and transportation; and packaging the HME material in a packaging tray in the presence of at least a protective gas, wherein the HME material may be a component for making a plant-based food product or used directly as a final food product.

In many embodiments, the process further comprises: optionally mixing at least an ingredient in a cooking tumbler to add flavor, texture, taste, or color to the HME material, passing the HME material cut as chunks through a cooling die; freezing the chunks using IQF-freezing or another known freezing method for preservation and transportation of the material; and packaging the chunks in the presence of protective gas, wherein the chunks may be a component for producing a plant-based food product or directly as a plant-based food product.

In many embodiments, the dough formed after mixing the batch of plant protein and water simultaneously within the mixer is further processed via the HME process, wherein the dough is fed into an extruder via a sausage filler. Use of the sausage filler forms a closed system trapping the air within the dough, and as the dough is processed via the extrusion process, air bubbles within the dough are homogeneously distributed throughout, providing sponginess or fluffiness, a texture, or color to the HME material without changing or altering the fiber structure of plant protein such that the HME material mirrors the meat-based food product.

In other embodiments, HME material prepared by the disclosed method is dry, crumbly, and spongy compared to the material prepared without following the disclosed method.

In various embodiments, plant protein and water are mixed in a ratio of 1:1.

In many embodiments, plant protein may be a soy protein, a pea protein, a wheat protein, milk protein, a protein powder blend, a vegetable protein, or other plant sourced protein comprising a high fiber content or a low fiber content. In many other embodiments, the plant-based food product is a vegan or a non-meat food product.

In various embodiments, provided herein is a batch mixing method of processing a plant-based food product, comprising: providing a batch of material comprising at least a plant protein and at least an aqueous phase, preferably water introduced simultaneously into a mixer, wherein the mixer blends the plant protein and water forming a dough which is dry and crumbly with air trapped within; feeding the dough through a feeding side of an extruder via a sausage filler, wherein the use of the sausage filler creates a closed system preventing air from the dough from leaving the system and back into the feeding side; subjecting the dough to a high moisture extrusion (HME) process forming a processed dough or HME material; passing the HME material through a cooling die; and cutting the HME material in chunks of any shape or size, wherein the HME material may be a component for making a plant-based food product or used directly as a final food product. In many other embodiments, the batch-mixing method further comprises: optionally mixing at least an additional ingredient of choice to add flavor, texture, taste, or color to the HME material in a cooking tumbler before or after cutting the HME material in chunks, wherein the HME material may be a component for making a plant-based food product or used directly as a final food product.

In many embodiments, the batch-mixing method further comprises: heating the HME material, wherein the HME material may be heated at least at a temperature of 80° C.; freezing the HME material, wherein the HME material is freeze via IQF-freezing for preservation, packaging, and transportation; and packaging the HME material in a packaging tray in the presence of at least a protective gas, wherein the HME material may be used as a component for producing a plant-based food product or used directly as a plant-based food product.

In many embodiments, the disclosure relates to a composition of making a plant-based food product, comprising: at least a plant protein, wherein the plant protein may be any plant-sourced protein or protein extracted from a plant; and at least an aqueous phase, preferably water, wherein plant protein and water are mixed simultaneously in batches in a mixer to prepare a dough, wherein the dough may be a component for producing a plant-based food product or used directly as a final food product. In many other embodiments, the composition further comprises optionally adding at least an ingredient to add flavor, taste, or color to the dough. In certain other embodiments, the composition comprises simultaneously mixing the plant protein and water within a batch-mixer in a ratio of 1:1, wherein mixing protein and water simultaneously forms a dry and crumbly dough with air bubbles. The dough formed is further processed via a high moisture extrusion process or HME process, wherein the dough is fed into an extruder using a sausage filler, creating a close system, such that the air bubbles within the dough are trapped within the system and homogeneously distribute the air bubbles as the dough undergoes the extrusion process providing sponginess, a texture, and color to the HME material, wherein the HME material mirrors a meat-food product, such as cooked chicken in color and texture.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The accompanying figures, where like reference numerals refer to steps of the process and embodiments, together with the detailed description below, are incorporated in and form part of the specification, and serve to further illustrate embodiments of concepts that include the claimed disclosure, and explain various principles and advantages of those embodiments.

The methods and composition disclosed herein have been represented where appropriate by conventional symbols in the flowcharts, photographs, or drawings, showing only those specific details that are pertinent to understanding the embodiments of the present disclosure so as not to obscure the disclosure with details that will be readily apparent to those of ordinary skill in the art having the benefit of the description herein.

FIG. 1 illustrates a flow chart showing an example standard method of making plant-based food products.

FIG. 2 illustrates a flow chart showing a batch mixing method of making and processing plant-based food products wherein a batch mixing step is added before a continuous extrusion process.

FIG. 3 illustrates a photograph showing a comparison of a food product prepared from a known process with the food product prepared from a batch mixing process.

The exemplary embodiments described and illustrated herein should be applicable to all plant-based food products.

### DETAILED DESCRIPTION

While the presently disclosed process and composition are susceptible of embodiment in many different forms, there is shown in the drawings and will herein be described in detail several specific embodiments with the understanding that the present disclosure is to be considered as an exemplification of the principles of the present technology and is not intended to limit the technology to the embodiments illustrated.

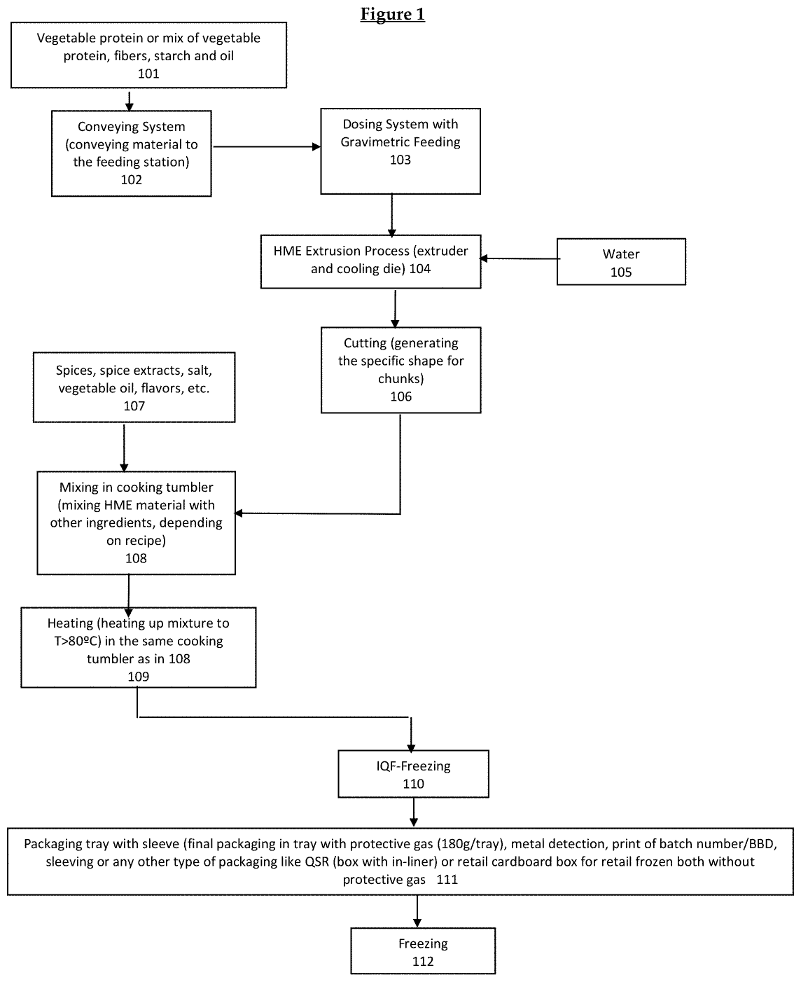

In summary, provided herein is a process of preparing and processing a plant-based food product, such as a vegan food product, and its composition thereof. More particularly, provided herein is a process and composition for making a vegan food product achieving a defined structure and color, wherein the structure and color of the plant-based food product are similar to a meat-based food product. FIG. 1 depicts a flow chart showing an example of a known process of making plant-based food products. As shown in FIG. 1, vegetable proteins (101) or a mix of vegetable protein, fibers, starch, and oil is introduced into a conveying system (102), wherein the conveying system conveys material such as vegetable protein (101) into a feeding station with gravimeter feeding (103). The material then passes through a high moisture extrusion (HME) process (104) wherein the material passes through an extruder and a cooling die. Water (105) is further added to the extruder directly after feeding the protein in powder form (101). The protein-water mix undergoes an HME extrusion process, forming a dough and then cutting (106), generating chunks.

The chunks may then be mixed with other ingredients (107) within a cooking tumbler (108) to add flavors to the finished product. The choice of ingredients may include but is not limited to, spices, spice extracts, salt, vegetable oil, or other such flavors depending on the recipe of choice. The spice-mixed chunks or spice-mixed material is further subjected to heating (109) at more than 80° C. temperature within the cooking tumbler. Following heating (109), the spice-mixed mixture or food product is introduced to IQF-freezing (110). The frozen material is then packaged in trays with sleeves (111). The final packaging of the material takes place in the presence of a protective gas. Processed material is packed in each tray followed in some cases by freezing (112). Further, other types of packaging may also be employed such as QSR (box with in-liner) or retail cardboard box for retail frozen. Both the QSR packaging and retail cardboard packaging can be done without the use of protective gas.

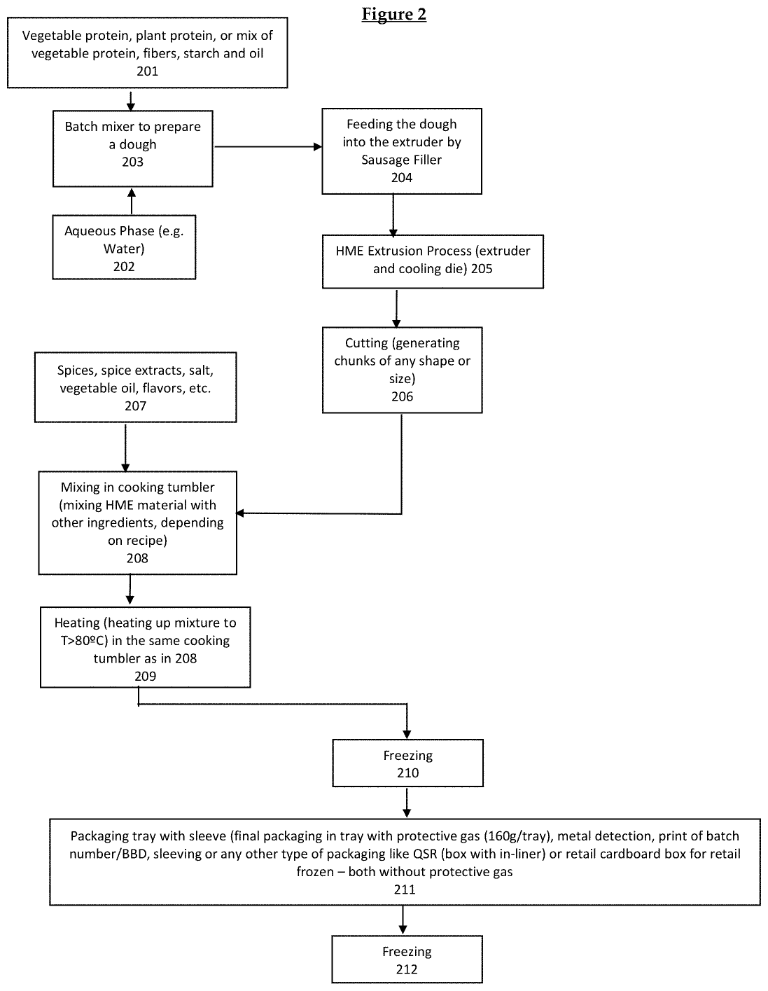

FIG. 2 illustrates a flow chart showing the disclosed process of making and processing a plant-based food product. As shown in the FIG. 2, vegetable protein or plant protein (201), such as plant-sourced protein or protein extracted from a plant and an aqueous phase, preferably water (202) is introduced simultaneously in batches into a mixer (203) to prepare a dough. The plant protein may be soy protein, pea protein, milk protein, wheat protein, plant-based proteins, protein extracted or sourced from a plant, protein powder blends, protein blends or protein mixtures or a mix of vegetable protein, fibers, starch, and oil. The plant protein powder/blend and water are mixed simultaneously in a batch mixer (203), forming the dry and crumbly dough with air bubbles. The protein and water may be mixed in a ratio of 1:1, 1:2 (one-part protein and two-parts water), 1:3 (one-part protein and three-parts water), 2:1 (two-parts protein and one-part water), 2:2 (two-parts protein and two-parts water), 3:1 (three-parts protein and one-part water), 1:4 (one-part protein and four-parts water), or another different ratio resulting in a dry and crumbly dough with air in it.

The dough prepared by the batch mixer method is fed into an extruder via a sausage filler (204). Feeding the dough into the extruder via a sausage filler provides many advantages, such as the system being closed thus, distributed air in the dough cannot go out of the extruder towards the feeding side. Whereas feeding protein in the form of a powder into the extruder, as shown in the standard process in FIG. 1, adds an uncontrolled amount of additional air into the extruder from the powder, causing issues during the HME process. Such issues are not present in the disclosed process as the dough is fed into the extruder instead of protein powder through the sausage filler creating an airtight system for the HME process. Owing to the use of a sausage filler to feed the dough into an extruder, the air within the dough does not leave the system and is in fact homogeneously distributed within the dough as very fine air bubbles. Although the air bubbles are not visible to the naked eye, the texture, sponginess, smoothness, density, and color of the finished food product appears very close to a meat food product, showing the effect of homogeneous distribution of air bubbles within the dough due to the batch mixing process as disclosed herein. The structure of the food product remains stable also after cooking, because the continuous phase, in this case the HME texturized plant protein or vegetable protein, is firm and will not collapse in a cooking step.

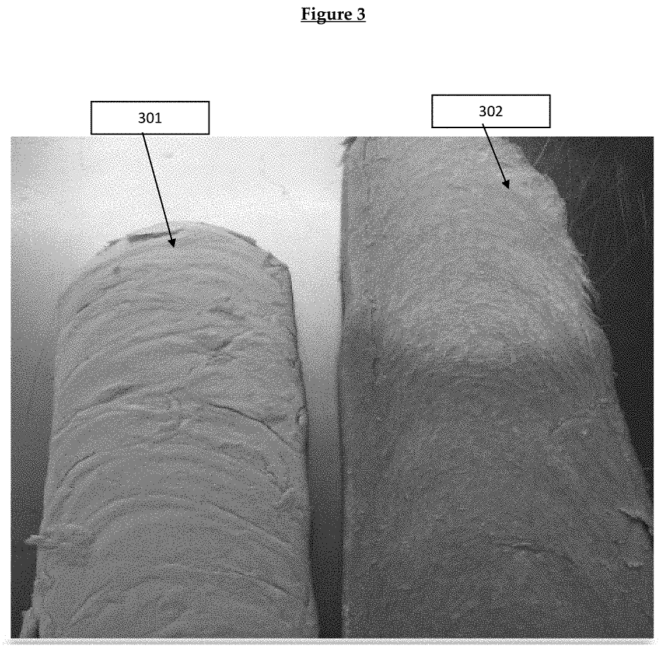

Therefore, homogeneous distribution of air bubbles resulting from the batch mixing process disclosed herein results in adding sponginess to the food product and a lighter color such as beige, light beige, or white, as further shown in FIG. 3 (product before cutting step) when compared with food product color produced using a standard process as disclosed in FIG. 1.

FIG. 2 further shows that after feeding the dough into an extruder using the sausage filler, the dough undergoes a HME process (205) wherein the dough passes through the extruder and a cooling die forming a processed HME material followed by cutting (206) the HME material in chunks (206) of any shape or size. The chunks or HME material is then mixed in a cooking tumbler (208) with other desired ingredients (207), including but not limited to, spices, spice extracts, salt, vegetable oil, flavors, etc. to add color, taste, texture, or flavor to the chunks. The choice of ingredients depends on the flavor, recipe, and type of food product produced through the process or user's preference. Once the desired ingredients (207) are mixed with the HME material in the cooking tumbler (208), the HME material may be subjected to heating (209) or the HME material is introduced to freezing for packaging and preservation. If the HME material is subjected to heating, the material may be heated at a temperature of 80° C. or more than 80° C. within the cooking tumbler.

Owing to the batch mixing process described in FIG. 2, the HME material/dough or food does not undergo a typical sudden pressure loss related expansion as the temperature of the cooling die is far below 100° C. Whereas, aerated extruded products generally expand at the outlet of the extruder die because of this pressure loss in passing the die, having a temperature T>100° C. (e.g. TVP, breakfast cereals, snacks). Therefore, the presently disclosed process provides advantage over the known methods.

The HME material undergoes IQF-freezing (210), wherein the HME material is frozen and prepared for preservation, transport, and sale. Following heating and freezing, the end food product or HME material in the shape of chunks is packaged in a packaging tray with at least one sleeve (211), which in some cases is followed by re-freezing (212). The final packaging is carried in the presence of a protective gas with at least 160 g of food product packaged per tray (211). The quantity of the food product packaged depends on a number of factors, including but not limited to, the density of the food product, size of the packaging tray, and size of the sleeves, among others.

Depending on these various factors, more or less than 180 g of the food product may be packaged per packaging tray (or another packaging). Further, other types of packaging may also be employed such as QSR (box with in-liner) or retail cardboard box for retail frozen. Both the QSR packaging and retail cardboard packaging can be done without the use of protective gas.

The packaged tray may be assigned a batch number or an identification number printed on the tray, sleeve, or other visible location. The packaging tray will also comprise metal detection or other such embodiments necessary and regularly employed as part of the food manufacturing, packaging, and transport process such as before the food product is sent to the customer, BBD is printed.

In some embodiments, a sausage filler may also be replaced by a powerful mono pump, wherein the dough maybe fed into the extruder via the mono pump. The presently disclosed batch mixing process as explained and shown in FIG. 2 provides certain advantages over the standard process disclosed in FIG. 1. The composition of the plant protein or vegetable protein and water ratio defines the structure of the finished product. As disclosed, the protein and water may be mixed in a ratio of 1:1, 1:2 (one-part protein and two-parts water), 1:3 (one-part protein and three-parts water), 2:1 (two-parts protein and one-part water), 2:2 (two-parts protein and two-parts water), 3:1 (three-parts protein and one-part water), 1:4 (one-part protein and four-parts water), or another desired ratio resulting in a dry and crumbly dough with air in it. Further, the choice of protein also has an effect on the finished food product. By way of example only and in no way limiting, use of soy protein concentrate with a high fiber content may also affect the final texture and structure of the finished food product. Proteins with high amount of fiber up to 20% may form a matrix structure that aids in immobilization of air from the dough or finished food product thus providing a lighter color and structure to the finished food products similar to meat food products. However, plant protein with low fiber content may also form plant-based food products using the batch mixing process as disclosed in FIG. 2 of the present disclosure.

Batch mixing as described in FIG. 2 forms a dry and crumbly dough with air trapped within it. Once the dough is introduced into the HME extrusion process via sausage filler, the system or the extrusion system completely shuts or closes, and as a result no air from the food or dough can escape from the dough to the feeding side. As a result, the air within the dough remains trapped within it, but due to the extrusion process is homogeneously distributed as fine air bubbles throughout the HME material. The homogeneous distribution of air bubbles could also make the final product slightly spongy or fluffy whereas fibry structure from the plant protein remains intact, thus providing a texture of aerated plant fiber but without any external gas. The homogeneous distribution of air bubbles resulting from the batch mixing process imparts a lighter color to the finished food product. The color of the food product is similar to the color of the meat, especially similar to cooked or fried chicken, or meat food products, or other cooked meat food products. Further, the batch mixing process also provides a lighter density to the food product as compared to the density of the food product made by known standard processes.

FIG. 3 depicts a photograph comparing the food product from an integrated batch mixing process (301) imparting a lighter color as compared to the food product (302) prepared using a standard known process, both after the HME process before cutting, wherein both the food products or dough are produced using the same soy protein concentration and water ratio. The soy dough produced using the disclosed batch mixing process is lighter in color (301), whereas the soy dough made using the standard known process is darker in color (302).

In the description, for purposes of explanation and not limitation, specific details are set forth, such as particular embodiments, procedures, techniques, etc. in order to provide a thorough understanding of the present technology. However, it will be apparent to one skilled in the art that the present technology may be practiced in other embodiments that depart from these specific details.

While specific embodiments of, and examples for, the process and compositions are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel or may be performed at different times.

While various embodiments have been described above, it should be understood that they have been presented by way of example only and not in limitation. The descriptions are not intended to limit the scope of the present technology to the particular forms set forth herein. On the contrary, the present descriptions are intended to cover such alternatives, modifications, and equivalents as may be included within the spirit and scope of the present technology as appreciated by one of ordinary skill in the art. Thus, the breadth and scope of a preferred embodiment should not be limited by any of the above-described exemplary embodiments.

The foregoing description of an implementation has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A method of preparing a plant-based food product, comprising:
providing a batch of material comprising at least a plant protein and at least an aqueous phase, preferably water, introduced simultaneously into a mixer, wherein the mixer blends the plant protein and water forming a dough and wherein the dough is dry and crumbly with air;
feeding the dough through a feeding side of an extruder via a sausage filler, wherein the use of the sausage filler forms a closed system preventing air from the dough from leaving the system and back into the feeding side;
subjecting the dough to a high moisture extrusion (HME) process forming HME material; and
cutting the HME material in chunks of any shape or size, wherein the HME material may be a component for producing a plant-based food product or used directly as a final food product.

2. The method of claim 1, wherein the method further comprises:
optionally mixing at least an ingredient in a cooking tumbler to add flavor, texture, taste, or color to the HME material.

3. The method of claim 1, wherein the method further comprises:
passing the HME material through a cooling die;
heating the HME material as chunks, wherein the chunks may be heated at a temperature of at least 80° C.;
freezing the HME material, wherein the HME material is freeze for preservation and transportation; and
packaging the HME material in the presence of protective gas, wherein the HME material may be a component for producing a plant-based food product or used directly as a plant-based food product.

4. The method of claim 1, wherein the plant protein and water are mixed in a ratio of 1:1.

5. The method of claim 1, wherein the plant protein may be soy protein.

6. The method of claim 1, wherein the plant protein may be pea protein.

7. The method of claim 1, wherein the plant protein may be wheat protein.

8. The method of claim 1, wherein the plant-based food product is a vegan food product.

9. The method of claim 1, wherein the HME process homogeneously distributes the air within the HME material as fine air bubbles throughout the HME material.

10. The method of claim 9, wherein the homogeneously distributed air bubbles make the food product spongy without changing the plant protein fiber structure.

11. A batch mixing method of processing a plant-based food product, comprising:
providing a batch of material comprising at least a plant protein and at least an aqueous phase, preferably water introduced simultaneously into a mixer, wherein the mixer blends the plant protein and water forming a dough and wherein the dough is dry and crumbly with air trapped within;
feeding the dough through a feeding side of an extruder via a sausage filler, wherein the use of sausage filler forms a closed system preventing air from the dough from leaving the system and back into the feeding side;
subjecting the dough to a high moisture extrusion (HME) process forming HME material; and
cutting the HME material in chunks of any shape or size, wherein the HME material may be a component for producing a plant-based food product or used directly as a final food product.

12. The batch-mixing method of claim 11, wherein the method further comprises:
optionally mixing at least an ingredient in a cooking tumbler to add flavor, texture, taste, or color to the HME material.

13. The batch-mixing method of claim 11, wherein the method further comprises:
passing the HME material through a cooling die;
heating the HME material as chunks, wherein the chunks may be heated at a temperature of at least 80° C.;
freezing the HME material, wherein the HME material is freeze for preservation and transportation; and
packaging the HME material in the presence of protective gas, wherein the HME material may be a component for producing a plant-based food product or used directly as a plant-based food product.

14. The batch-mixing method of claim 11, wherein the plant protein and water are mixed in a ratio of 1:1.

15. The batch-mixing method of claim 11, wherein the plant protein may be soy protein.

16. The batch-mixing method of claim 11, wherein the plant protein may be pea protein.

17. The batch-mixing method of claim 11, wherein the plant protein may be wheat protein.

18. The batch-mixing method of claim 11, wherein the plant-based food product is a vegan food product.

19. The batch-mixing method of claim 11, wherein the HME process homogeneously distributes the air within the HME material as fine air bubbles throughout the HME material.

20. The batch-mixing method of claim 19, wherein the homogeneously distributed air bubbles make the food product spongy without changing the plant protein fiber structure.

21. A composition of making a plant-based food product, comprising:
at least a plant protein, wherein the plant protein is a plant sourced protein; and
at least an aqueous phase, preferably water, wherein plant protein and water are provided and mixed simultaneously in a batch-mixer to prepare a dough, wherein the dough may be a component for producing a plant-based food product or used directly as a final food product.

22. The composition of claim 21, wherein the composition further comprises optionally adding at least an ingredient to provide flavor, texture, taste, or color to the dough.

23. The composition of claim 21, wherein the plant protein and water are mixed in a ratio of 1:1.

24. The composition of claim 21, wherein the plant protein may be soy protein.

25. The composition of claim 21, wherein the plant protein may be pea protein.

26. The composition of claim 21, wherein the plant protein may be wheat protein.

27. The composition of claim 21, wherein the plant-based food product is a vegan food product.
